(19) United States
(12) Patent Application Publication
(10) Pub. No.: US 2024/0372121 A1
(43) Pub. Date: Nov. 7, 2024

(54) METHOD FOR PRODUCING A MEMBRANE ELECTRODE ASSEMBLY (MEA), MEMBRANE ELECTRODE ASSEMBLY, AND FUEL CELL COMPRISING A MEMBRANE ELECTRODE ASSEMBLY

(71) Applicant: Robert Bosch GmbH, Stuttgart (DE)

(72) Inventors: Andreas Ringk, Bamberg (DE); Anton Ringel, Bamberg (DE)

(21) Appl. No.: 18/686,977

(22) PCT Filed: Aug. 2, 2022
(86) PCT No.: PCT/EP2022/071727

§ 371 Date: Feb. 27, 2024

(30) Foreign Application Priority Data
Sep. 1, 2021 (DE) 10 2021 209 580.1

(51) Int. Cl. H01M 8/1004; H01M 8/0239; H01M 8/0286

(52) U.S. Cl. CPC H01M 8/1004; H01M 8/0239; H01M 8/0286

(57) ABSTRACT

The invention relates to a method for producing a membrane electrode assembly (10) for a fuel cell, wherein a membrane (1), preferably a polymer membrane, is coated on both sides with a catalytically active material in order to form a first and a second electrode (2, 3) and a sealant and/or adhesive (7) is applied to at least one end face (8) of the coated membrane (1), by means of which sealant or adhesive the coated membrane (1) is connected to two plastic films (5, 6) lying one on top of the other to form a gasket (4).

The invention further relates to a membrane electrode assembly (10) and to a fuel cell comprising a membrane electrode assembly (10) according to the invention.

### BACKGROUND

The invention relates to a method of manufacturing a membrane electrode assembly for a fuel cell. Furthermore, the invention relates to a membrane electrode assembly and a fuel cell with a membrane electrode assembly according to the invention.

With the help of a fuel cell, chemical energy can be converted into electrical energy using a fuel, for example hydrogen, and an oxidizing agent, for example oxygen. For this purpose, the fuel cell has a membrane electrode assembly (MEA) with a membrane that is coated on both sides with a catalytically active material to form electrodes. To reinforce the edges, the membrane, which is coated on both sides, is usually laminated between two plastic films. This type of edge reinforcement is also known as a “gasket”. The two plastic films have large windows so that the coated membrane remains free except for a narrow surrounding edge area. The free surfaces form active surfaces via which the proton exchange required for the electrochemical reaction takes place during operation of the fuel cell.

When forming the gasket or laminating the coated membrane, approx. 6% of the active surface is covered by adhesive and thus deactivated. This has a negative effect on the performance of the fuel cell.

The present invention is therefore based on the task of improving the performance of a fuel cell with a laminated membrane electrode assembly. Furthermore, the membrane electrode assembly should be as simple and inexpensive as possible to manufacture.

### SUMMARY

To solve the problem, the method and the membrane electrode assembly of the disclosure are proposed. Furthermore, a fuel cell with a membrane electrode assembly according to the invention is disclosed.

A method for manufacturing a membrane electrode assembly for a fuel cell is proposed. In the method, a membrane, preferably a polymer membrane, is coated on both sides with a catalytically active material to form a first and a second electrode. In the method, a sealant and/or adhesive is also applied to at least one end face of the coated membrane, via which the coated membrane is bonded to two plastic films lying one on top of the other to form a gasket.

The sealant and/or adhesive applied to the at least one end face of the coated membrane forms a gas barrier which serves to separate the reaction gases during operation of the subsequent fuel cell. At the same time, the sealant and/or adhesive creates a bond between the coated membrane and the plastic films of the gasket, so that a further adhesive bond is not required. The adhesive bond between the membrane and the plastic films can therefore be limited to this. In particular, the active surfaces of the coated membrane can remain adhesive-free so that they are not covered or deactivated by adhesive. In this way, the performance of the membrane electrode assembly and thus of the fuel cell can be increased. At the same time, adhesive consumption is reduced. As a result, the weight of the fuel cell can also be reduced.

Preferably, the sealant and/or adhesive is applied to all end faces of the coated membrane, so that the membrane is connected to the two plastic films of the gasket all the way around via the sealant and/or adhesive. At the same time, a circumferential gas barrier is formed in this way.

According to a preferred embodiment of the invention, the sealant and/or adhesive is applied over the entire surface of the at least one end face of the coated membrane. This means that the sealant and/or adhesive extends over the entire end face of the coated membrane, so that the electrodes are also covered by the sealant and/or adhesive on the end face. This further optimizes the gas barrier formed by the sealant and/or adhesive.

Advantageously, at least one surface of the membrane coated with catalytically active material is kept free of the sealant and/or adhesive in order to increase the performance of the membrane electrode assembly or the fuel cell comprising the membrane electrode assembly. This does not preclude the membrane from being bonded to at least one side of a plastic film of the gasket. In this case, however, an adhesive is preferably used for bonding which differs from the sealant and/or adhesive applied to the at least one end face of the membrane. This is because the adhesive applied to the surface of the coated membrane does not have to form a gas barrier. This function is performed by the sealant and/or adhesive applied to the end face. By using a suitable adhesive, the connection between the membrane and the gasket can be optimized.

It is further proposed that at least one surface of the membrane coated with catalytically active material is covered with a mask, preferably a stamp mask, before the sealant and/or adhesive is applied. The at least one mask ensures that the sealant and/or adhesive is applied solely to the at least one end face of the coated membrane. Preferably, both coated surfaces of the membrane are each covered with a mask so that only the end faces of the membrane are exposed.

The advantage of using at least one stamp mask as a mask is that the masking can be carried out at the same time as the coated membrane is produced. For example, the membrane can be produced by punching from a polymer web coated on both sides with a catalytically active material. The punch masks used during punching can then remain as masks on the membrane during the subsequent application of the sealant and/or adhesive, as they only expose the end faces of the coated membrane. The surfaces of the membrane coated with catalytically active material are thus optimally protected.

The sealant and/or adhesive can be sprayed, spritzed, brushed, rolled, sputtered, or vaporized onto the at least one end face of the coated membrane. With the aid of these application methods, the application of the sealant and/or adhesive—with or without masking—can be restricted to one or more end faces of the coated membrane, so that the surfaces coated with the catalytically active material remain free of the sealant and/or adhesive.

The sealant and/or adhesive can also be applied by means of plasma treatment, preferably in a plasma chamber, or by immersing the coated membrane in an immersion bath. In this case, the surfaces coated with the catalytically active material must be covered or masked beforehand in order to limit the application to one or more end faces of the coated membrane.

The membrane electrode assembly also proposed for a fuel cell comprises a membrane, preferably a polymer membrane, which is coated on both sides with a catalytically active material to form a first and a second electrode and is enclosed by two plastic films lying one on top of the other to form a gasket. The membrane is connected to the two plastic films by means of a sealant and/or adhesive, which is arranged exclusively on one or more end faces of the coated membrane.

Due to the frontal arrangement of the sealant and/or adhesive, it forms a gas barrier. The gas barrier is later used to separate the reaction gases during operation of a fuel cell with a membrane electrode assembly. Since the sealant and/or adhesive is only arranged on the end face, the surfaces of the membrane coated with the catalytically active material remain free of the sealant and/or adhesive. This means that the active surfaces of the coated membrane are not covered or deactivated by the sealant and/or adhesive. The membrane electrode assembly or the fuel cell with the membrane electrode assembly thus exhibits increased performance. At the same time, it is more cost-effective to manufacture, as there is no need for sealant and/or adhesive. At the same time, the membrane electrode assembly has a lower weight.

The proposed membrane electrode assembly can be manufactured in particular according to the method of the invention described above.

Preferably, the two plastic films of the gasket have a common overlap area with the coated membrane. The overlapping arrangement results in improved reinforcement of the membrane. If no sealant and/or adhesive is applied in the overlap area, the entire surface of the membrane coated with a catalytically active material can be used as an active surface.

However, the two plastic films of the gasket can also be bonded to the membrane and/or to each other using an adhesive that is different from the sealant and/or adhesive. In this way, the connection of the two plastic films with each other and/or with the membrane can be improved. The adhesive can only be applied in certain areas, i.e., not all the way around, so that the reaction gases continue to pass between the respective plastic film and the membrane at the points where there is no adhesive between the plastic films and the membrane. The active area is therefore only deactivated where adhesive is applied to a coated surface of the membrane. If the adhesive is only applied between the two plastic films in order to bond them together, the active surfaces of the membrane can still be used in their entirety.

Furthermore, a fuel cell for a fuel cell stack is proposed, which comprises a membrane electrode assembly according to the invention. Thanks to the membrane electrode assembly according to the invention, the fuel cell has a better performance. It is also more cost-effective to produce, as adhesive and possibly film material can be saved. The material savings also reduce the weight of the fuel cell.

### BRIEF DESCRIPTION OF THE DRAWINGS

Preferred embodiments of the invention are described in greater detail hereinafter with reference to the accompanying drawings. Shown are:

FIG. 1 a cross-section through a first membrane electrode assembly according to the invention,

FIG. 2 a cross-section through a second membrane electrode assembly according to the invention,

FIG. 3 a cross-section through a third membrane electrode assembly according to the invention,

FIG. 4 a perspective view of a punching device for producing a membrane-electrode assembly when masking the membrane coated on both sides,

FIG. 5 a perspective view of the punching device of FIG. 4 during punching of the membrane,

FIG. 6 a perspective view of the punched masked membrane, and

FIG. 7 a perspective view of the stamped punched membrane when spraying a side surface.

### DETAILED DESCRIPTION

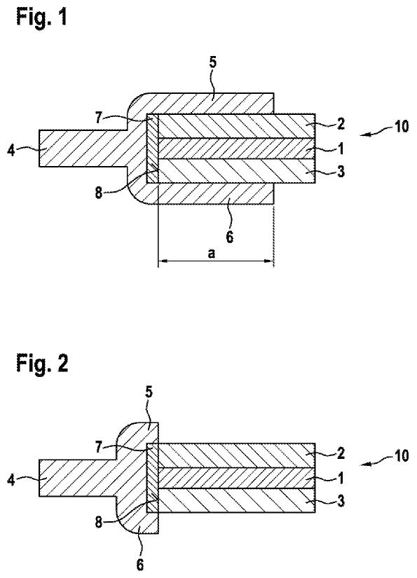

The membrane electrode assembly 10 shown in FIG. 1 comprises a membrane 1 coated on both sides with a catalytically active material to form electrodes 2, 3. Electrode 2 forms a cathode and electrode 3 an anode. The membrane 1 has a sealant and/or adhesive 7 on an end face 8, so that a gas barrier is formed. At the same time, the sealant and/or adhesive 7 is used to create a connection between the membrane 1 and two plastic films 5, 6 of a gasket 4 surrounding the membrane 1. The gasket 4 stiffens the membrane 1. For this purpose, the plastic films 5, 6 are guided up to the membrane 1 so that they cover the electrodes 2, 3 in a common overlap area a. However, since there is no sealant and/or adhesive between the plastic films 5, 6 and the coated surfaces of the membrane 1, the reaction gases can get under the plastic films 5, 6 so that the active surfaces of the membrane 1 are not deactivated.

FIG. 2 shows a further preferred embodiment of a membrane electrode assembly 10 according to the invention. This differs from that of FIG. 1 in that a common overlap area a has been omitted. The plastic foils 5, 6 end in front of the electrodes 2, 3, so that the active surfaces of the membrane 1 are completely exposed.

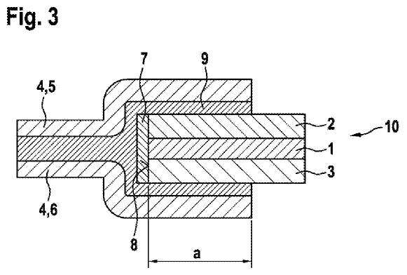

A further preferred embodiment of a membrane electrode assembly 10 according to the invention is shown in FIG. 3. In addition to the sealant and/or adhesive 7 applied to the front of the membrane 1, an adhesive 9 is provided, which is used to bond the plastic films 5, 6 to each other and to the membrane 1. The bonding takes place in a common overlap area a, wherein the adhesive 9 is preferably only applied in certain areas, i.e., not all the way around, so that the reaction gases can pass between the plastic films 5, 6 and the coated membrane 1 in the adhesive-free areas.

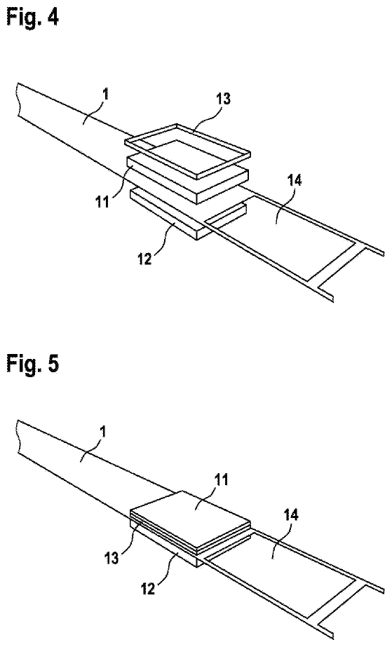

A preferred method for manufacturing a membrane electrode assembly 10 according to the invention is described below with reference to FIGS. 4 through 7.

First, the membrane 1 is produced by punching from a polymer web coated on both sides with a catalytically active material. For this purpose, masks 11, 12 are applied to both sides of the polymer web as stamp masks (see FIG. 4), the dimensions of which correspond to the dimensions of the membrane 1. The membrane 1 is then punched out of the polymer web using a punching tool 13 (see FIG. 5). A correspondingly large punched hole 14 then remains in the polymer web.

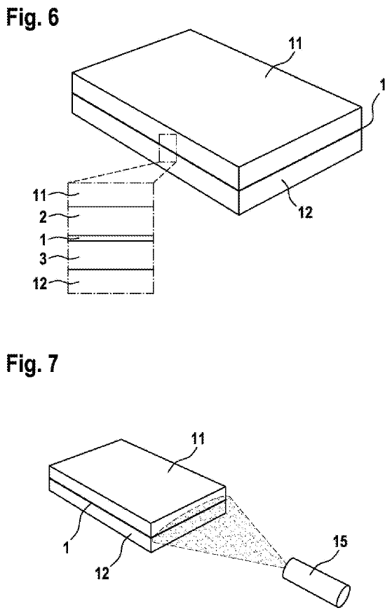

The masks 11, 12 remain on the membrane 1 after punching, so that the surfaces of the membrane 1 coated with the catalytically active material are completely covered (see FIG. 6). With appropriate masking, the sealant and/or adhesive 7 can then be applied, for example sprayed, to the at least one end face 8 of the membrane 1. A spraying device 15 can be used for this purpose (see FIG. 7).

1. A method for producing a membrane electrode assembly (10) for a fuel cell, in which a membrane (1) is coated on both sides with a catalytically active material to form a first and a second electrode (2, 3), and in which a sealant and/or adhesive (7) is applied to at least one end face (8) of the coated membrane (1), by which the coated membrane (1) is connected to two plastic films (5, 6) lying one on top of the other to form a gasket (4).

2. The method according to claim 1,
wherein the sealant and/or adhesive (7) is applied over an entire surface of the at least one end face (8) of the coated membrane (1).

3. The method according to claim 1,
wherein at least one surface of the membrane (1) coated with catalytically active material is kept free of the sealant and/or adhesive (7).

4. The method according to claim 1, one of the preceding claims,
wherein at least one surface of the membrane (1) coated with catalytically active material is covered with a mask (11, 12), before the sealant and/or adhesive (7) is applied.

5. The method according to claim 1,
wherein the sealant and/or adhesive (7) is sprayed, spritzed, brushed, rolled, sputtered, or vapor-deposited onto the at least one end face (8) of the coated membrane (1).

6. The method according to claim 1,
wherein the sealant and/or adhesive (7) is applied by plasma treatment or by immersing the coated membrane (1) in an immersion bath.

7. A membrane electrode assembly (10) for a fuel cell, comprising a membrane (1) which is coated on both sides with a catalytically active material to form a first and a second electrode (2, 3), and which is surrounded by two plastic films (5, 6) lying one on top of the other to form a gasket (4), wherein a connection of the membrane (1) to the two plastic films (5, 6) is produced via a sealant and/or adhesive (7) which is arranged exclusively on one or more end faces (8) of the coated membrane (1).

8. The membrane electrode assembly (10) according to claim 7,
wherein the two plastic films (5, 6) of the gasket (4) have a common overlap area (a) with the coated membrane (1).

9. The membrane electrode assembly (10) according to claim 7,
wherein the two plastic films (5, 6) of the gasket (4) are bonded to the membrane (1) and/or to one another by an adhesive (9) which is different from the sealant and/or adhesive (7).

10. A fuel cell for a fuel cell stack, comprising a membrane electrode assembly (10) according to claim 7.

11. The method according to claim 1, wherein the membrane (1) is a polymer membrane.

12. The method according to claim 4, wherein the mask (11, 12) is a stamp mask.

13. The method according to claim 6, wherein the sealant and/or adhesive (7) is applied by plasma treatment in a plasma chamber.

14. The membrane electrode assembly (10) according to claim 7, wherein the membrane (1) is a polymer membrane.
